(19) United States
(12) Patent Application Publication
(10) Pub. No.: US 2010/0117793 A1
(43) Pub. Date: May 13, 2010

(54) PHOTOGRAPHING CONTROL APPARATUS, PROGRAM AND METHOD OF THE SAME, AND PHOTOGRAPHING APPARATUS

(75) Inventors: Sachiko KUMAGAI, Chiba (JP); Eigo Segawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/567,014

(22) Filed: Sep. 25, 2009

Related U.S. Application Data
(63) Continuation of application No. PCT/JP2007/056943, filed on Mar. 29, 2007.

(51) Int. Cl. G06F 7/04; G06K 9/00; H04N 5/228

(52) U.S. Cl. 340/5.81; 382/115; 348/222.1; 348/E05.031

(57) ABSTRACT

An imaging control apparatus for controlling an imaging apparatus that presents presentation information and captures an image of a person, the imaging control apparatus includes: an identification information acquisition unit that acquires identification information; an information presentation instruction unit that refers to presentation information setting information which associates the identification information and the presentation information with each other, and instructs the imaging apparatus to present presentation information that the presentation information setting information associates with identification information acquired by the identification information acquisition unit; and an imaging instruction unit that instructs the imaging apparatus to capture an image of the person while the instruction presentation instruction unit instructs to present the presentation information.

### CROSS-REFERENCE TO RELATED APPLICATIONS

This application is a continuation application, filed under 35 U.S.C. §111(a), of PCT Application No. PCT/JP2007/056943, filed Mar. 29, 2007, the disclosure of which is herein incorporated in its entirety by reference.

### FIELD

The present invention relates to a photographing control apparatus, a program and method of the same, and a photographing apparatus which present presentation information to draw attention of a person to be photographed and take his/her face shot properly without a hitch.

### BACKGROUND

Face authentication has been conventionally known as one of biometric authentication technologies. As compared to other biometric authentications, face authentication imposes less psychological burdens on the user, whereas the face of the person to be photographed or the person to be authenticated needs to be turned to a proper direction with respect to the photographing camera. In order to take a face picture in a direction appropriate for face authentication, a method of guiding a person to be photographed so as to look to a proper direction has been known (for example, see Patent Document 1). There has also been a known method in which a flash lamp provided on a photographing apparatus is ignited to make the person to be photographed look to the front of the camera and take a face shot, utilizing the fact (key stimulus) that a visual stimulus from instantaneous strong light induces an instinctive human behavior to look to the light source (for example, see Patent Document 2).

For a conventional technique relevant to the present invention, it has been known to play a sound or display an image that interests the person to be photographed so that the person to be photographed looks to the camera (for example, see Patent Document 3).
[Patent Document 1] Japanese Laid-Open Patent Publication No. 2003-141541
[Patent Document 2] Japanese Laid-Open Patent Publication No. 2005-094710
[Patent Document 3] Japanese Laid-Open Patent Publication No. 2005-164623

With the technology of Patent Document 1, it can be expected that the person to be photographed turns the face according to the guidance that appears on the display if the person to be photographed voluntarily takes a face shot for authentication or other purposes. It is difficult, however, to make the person to be photographed turn the face by guidance if it is undesirable to let the person to be photographed aware of the photographing in a car-mount service system or the like, or if there is no benefit for the person to be photographed to follow the guidance in such cases as photographing for surveillance purpose.

The technology of Patent Document 2 is considered to be effective when used against suspicious individuals. In service systems that perform authentication on the same person to be photographed repeatedly, on the other hand, the strong light will be administered to the person to be photographed each time face authentication is performed. There is another problem that the person to be photographed will get accustomed to the repetition of the same stimulus and no longer turn the face.

Similarly, in Patent Document 3, the person to be photographed will get accustomed to and uninterested in the presented information if there is no change. Some contrivances are thus desirably made to change the information to be presented. In such a case, a video image or the like may be used as the information to be presented to the person to be photographed. Face authentication may not be performed properly, however, if the person to be photographed gazes at the video image with a change in facial expression. In face authentication systems targeted for a plurality of persons to be photographed (such as when performing face authentication at an automated ticket gate of a station), photographing or passage will be hindered if a person to be photographed is interested in the presented information and stops.

### SUMMARY

According to an aspect of the invention, an imaging control apparatus for controlling an imaging apparatus that presents presentation information and captures an image of a person, the imaging control apparatus includes: an information presentation instruction unit that refers to presentation information setting information which is designed for attracting the interest of the person, and instructs the imaging apparatus to present presentation information that the presentation information setting information; and an imaging instruction unit that instructs the imaging apparatus to capture an image of the person while the instruction presentation instruction unit instructs to present the presentation information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the overall configuration of a first embodiment.

FIG. 2 is a diagram (part I) illustrating an example of information presented by an information presentation unit of the first embodiment.

FIG. 3 is a diagram (part II) illustrating an example of information presented by the information presentation unit of the first embodiment.

FIG. 4 is a diagram illustrating a presentation information setting table according to the first embodiment.

FIG. 5 is a diagram illustrating an example of image capturing mode in personal authentication according to the first embodiment.

FIG. 6 is a diagram illustrating an example of image capturing mode in multiple authentication according to the first embodiment.

FIG. 7 is a flowchart illustrating the operation of a control information receiving unit according to the first embodiment.

FIG. 8 is a flowchart illustrating the operation of a determination apparatus according to the first embodiment.

FIG. 9 is a flowchart illustrating an example of the operation of the determination apparatus in the first embodiment when the next person is photographed after the result of determination is output.

FIG. 10 is a flowchart illustrating the operation of a photographing instruction unit according to the first embodiment.

FIG. 11 is a flowchart illustrating the operation of a information presentation instruction unit according to the first embodiment.

FIG. 12 is a flowchart illustrating the overall operation when presentation information is selected according to the first embodiment.

FIG. 13 is a block diagram illustrating an example of the overall configuration of a second embodiment.

FIG. 14 is a block diagram illustrating an example of the overall configuration of a third embodiment.

FIG. 15 is a block diagram illustrating an example of the overall configuration of a fourth embodiment.

FIG. 16 is a latest presentation information table retained in a presentation information receiving unit according to the fourth embodiment.

FIG. 17 is a flowchart illustrating the operation of the information presentation instruction unit according to the fourth embodiment.

FIG. 18 is a block diagram illustrating the overall configuration of a fifth embodiment.

FIG. 19 is a block diagram illustrating the overall configuration of a sixth embodiment.

### DESCRIPTION OF EMBODIMENTS

Hereinafter, embodiments of the present invention will be described with reference to the drawings.

### First Embodiment

Initially, the overall configuration of a photographing system according to a first embodiment will be described.

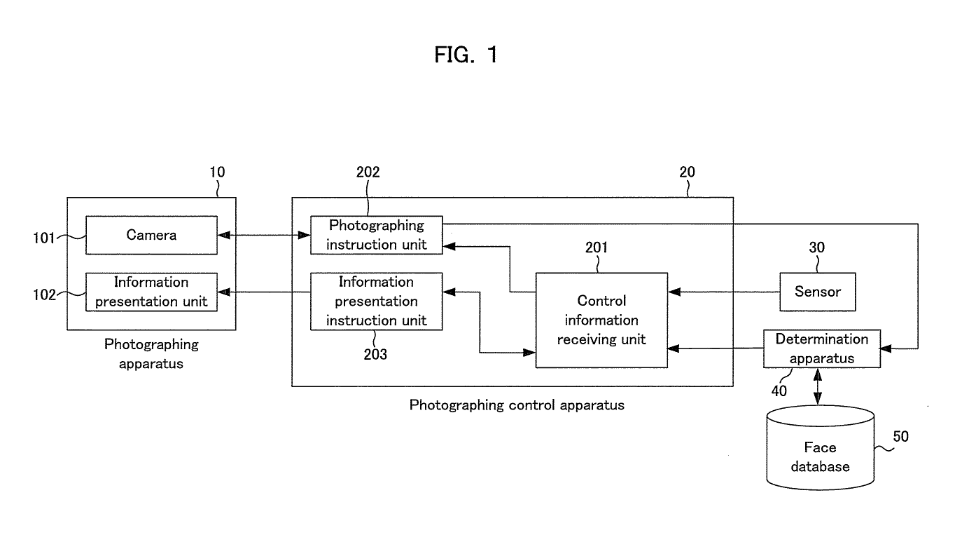

FIG. 1 is a block diagram illustrating an example of the overall configuration of the first embodiment. The photographing system includes: a photographing apparatus 10 which can capture an image of a person to be photographed who is an authentication subject for face authentication to be performed on; a photographing control apparatus 20 which controls the photographing apparatus 10; a sensor 30 which detects the presence of a person to be photographed in the shooting range; a determination apparatus 40 which determines the face direction of the person to be photographed; and a face database 50 in which face data is registered.

The photographing apparatus 10 includes a camera 101 and an information presentation unit 102.

The photographing control apparatus 20 includes a control information receiving unit 201, a photographing instruction unit 202, and an information presentation instruction unit 203.

The camera 101 of the photographing apparatus 10 shoots the person to be photographed who is in the detection range (shooting range) of the sensor 30. The information presentation unit 102 of the photographing apparatus 10 presents information that interests the person to be photographed. The information presentation unit 102 is installed in a position such that the person to be photographed, or the shooting subject of the camera 101, faces to a direction appropriate for photographing when the person to be photographed looks to the information presentation unit 102.

The control information receiving unit 201 of the photographing control apparatus 20 receives signals from the sensor 30 and the determination apparatus 40, and issues instructions to the photographing instruction unit 202 and the information presentation instruction unit 203. The photographing instruction unit 202 of the photographing control apparatus 20 receives the instruction from the control information receiving unit 201, issues an instruction to start shooting or an instruction to stop shooting to the camera 101, and transmits a picture taken by the camera 101 to the determination apparatus 40. The information presentation instruction unit 203 of the photographing control unit 20 receives the instruction from the control information receiving unit 201, and issues an instruction to start information presentation or an instruction to stop information presentation to the information presentation unit 102.

The information presentation instruction unit 203 retains a plurality of pieces of presentation information, selects presentation information in order or at random, and makes the information presentation unit 102 present the presentation information selected. The presentation information may be optical information or sound information as long as it can be identified and its contents can be grasped by the person to be photographed in a short time.

The sensor 30 detects the presence or absence of a person (person to be photographed) in the shooting range of the camera 101. The sensor 30 transmits a “presence” signal to the control information receiving unit 201 if a person is sensed, and transmits an “absence” signal if not. The sensor 30 may be made of any sensor such as a pyroelectric sensor, pressure sensor, and card read sensor, as long as it can detect the presence or absence of a person. When detecting the presence or absence of a person, the sensor 30 may read identification information attached to a card, for example.

The face database 50 contains information for identifying persons to be photographed, such as the facial images of the persons to be photographed shot by the camera 101, as reference face data. The face data is data for authenticating certain faces, and contains facial characteristics in numerical expression. The face data may be registered in advance for authentication.

The determination apparatus 40 determines whether or not the face of a person to be photographed is oriented in a direction appropriate for photographing. The determination apparatus 40 also compares and collates the shot face picture with the face data stored in the face database 50. That is, the determination apparatus 40 can function also as a face authentication apparatus.

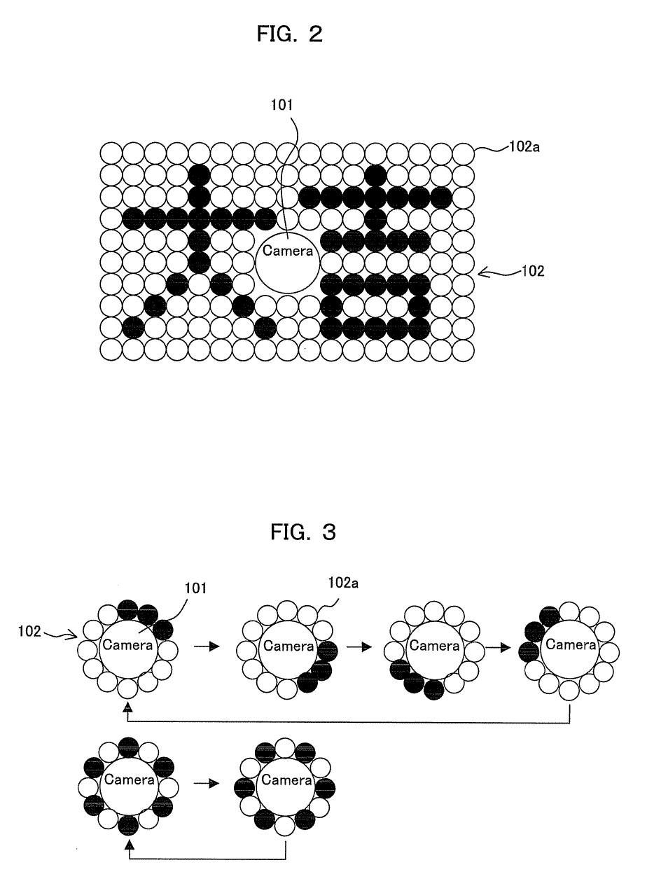

FIGS. 2 and 3 are diagrams illustrating examples of the information presented by the information presentation unit 102 of the first embodiment.

In FIG. 2, the information presentation unit 102 has a display which includes a plurality of light-emitting parts 102a. The plurality of light-emitting parts 102a are individually controlled in light emission so as to display a fortune message. The display represents a plurality of fortune messages at random or in predetermined order. The camera 101 is arranged near the center of the presentation area (display) of the information presentation unit 102.

In FIG. 3, the information presentation unit 102 is configured so that a plurality of light-emitting parts 102a are arranged around the camera 101 and flicker in various patterns. The patterns are selected at random or in predetermined order. Such a plurality of pieces of presentation information to be presented by the information presentation unit 102 can be selected from among the information retained in the information presentation instruction unit 203.

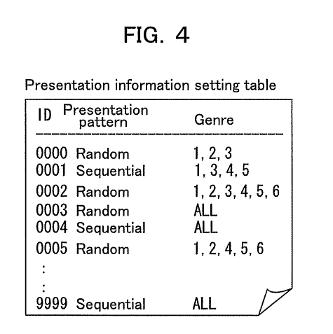

The information presentation instruction unit 203 retains a presentation information setting table illustrated in FIG. 4. In FIG. 4, ID represents information that is read by the sensor (such as a card reader) 30 or information that is attached to face data. The genre in FIG. 4 illustrates the presentation content selected. The presentation pattern represents the pattern that is used to select which piece of information to present in the genre selected. According to such a table, when ID 0000 is read by the sensor 30, one of genres (types of presentation information) 1, 2, and 3 is selected at random, and presentation information selected is transmitted to the information presentation unit 102 for presentation.

It should be noted that the first embodiment is predicated on personal authentication or multiple authentication use. Description will hereinafter be given of the personal authentication and multiple authentication according to the first embodiment.

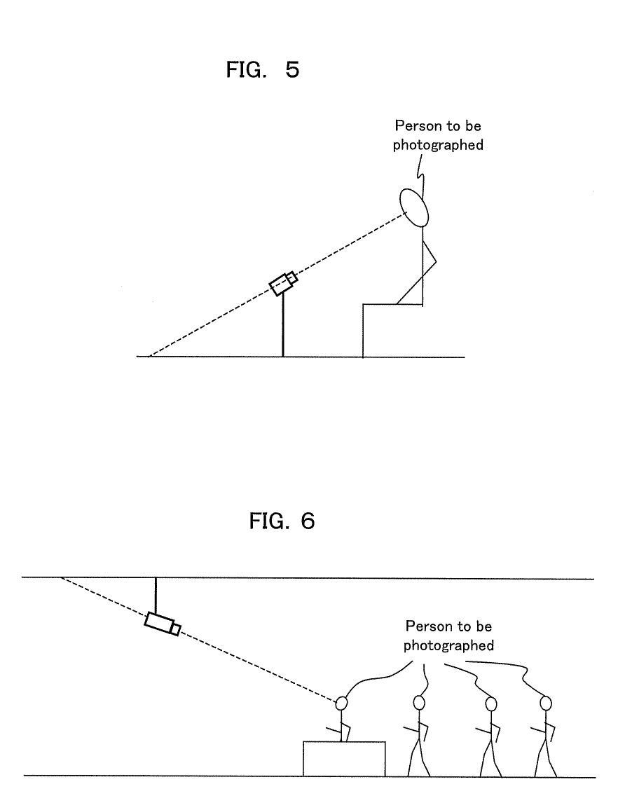

FIG. 5 is a diagram illustrating an example of the personal authentication according to the first embodiment. FIG. 6 is a diagram illustrating an example of the multiple authentication according to the first embodiment.

Personal authentication illustrated in FIG. 5 is used, for example, in a service system and a surveillance system that are implemented by performing authentication on a passenger of a vehicle. Authentication on a plurality of persons to be photographed illustrated in FIG. 6 is used, for example, in a service system and a surveillance system in which a camera is installed at a ticket gate of a station. When persons to be photographed pass the gate, information-retaining media such as an IC card are read by a sensor and face authentication is performed on the persons to be photographed.

In FIG. 5, the presentation information and the display pattern of the presentation information are set by the passenger. In FIG. 6, the persons to be photographed set the presentation information or type thereof in advance, and IDs for identifying the persons to be photographed are attached to their respective information-written media such as an IC card, so that predetermined types of presentation information set by the information presentation instruction unit 203 can be presented when the IDs are read by the sensor 30. Based on the IDs for identifying the persons to be photographed, information previously set by the information presentation instruction unit may be selected and presented as presentation information depending on age, gender, occupation, etc.

Next, description will be given of the operation of the control information receiving unit according to the first embodiment.

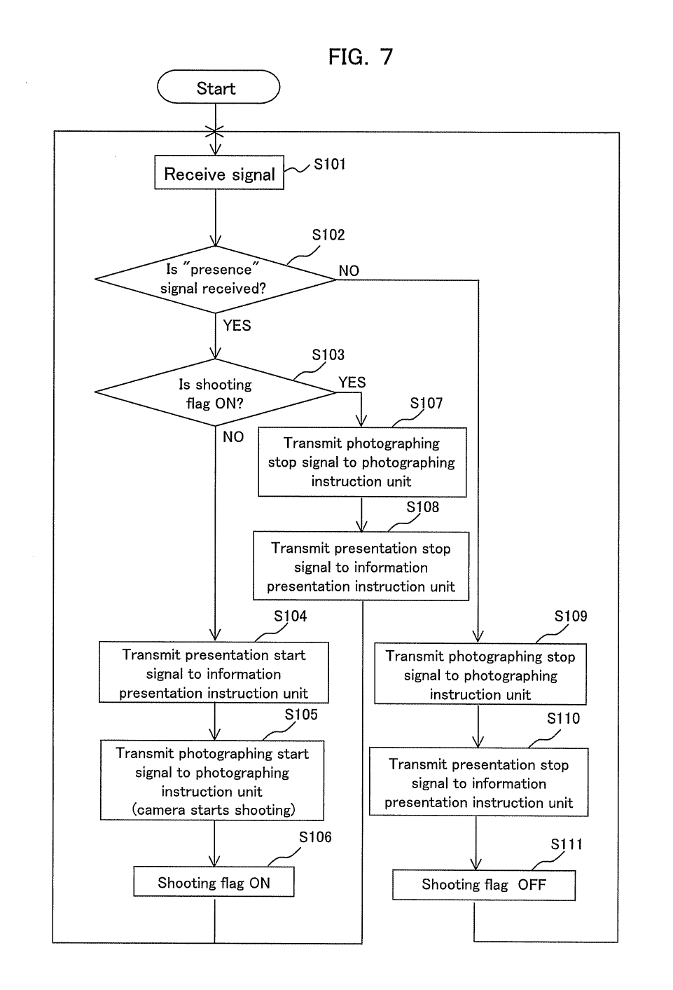

FIG. 7 is a flowchart illustrating the operation of the control information receiving unit according to the first embodiment. In the chart, a shooting flag inside the control information receiving unit 201 indicates the state where the camera 101 is currently shooting as “ON,” and the state where the camera 101 is not shooting as “OFF.” In an initial state, the shooting flag is “OFF.” The sensor 30 outputs the “presence” signal if any person to be photographed is in the shooting coverage, and the “absence” signal if not.

Initially, the control information receiving unit 201 receives a signal from the sensor 30 (S101). The control information receiving unit 201 determines whether or not the “presence” signal is received from the sensor 30 (S102).

If it is determined in step S102 that the control information receiving unit 201 receives the “presence” signal (S102, YES), the control information receiving unit 201 determines whether or not the shooting flag is “ON” (S103).

If it is determined in step S103 that the shooting flag is “OFF” (S103, NO), the control information receiving unit 201 transmits an information presentation start signal to the information presentation instruction unit 203 (S104), transmits a photographing start signal to the photographing instruction unit 202 (S105), sets the shooting flag “ON” (S106), and returns to step S101.

On the other hand, if it is determined in step S103 that the shooting flag is “ON” (S103, YES), the control information receiving unit 201 transmits a photographing stop signal to the photographing instruction unit 202 (S107), transmits an information presentation stop signal to the information presentation instruction unit 203 (S108), and returns to step S101.

If it is determined in step S102 that the control information receiving unit 201 receives the “absence” signal (S102, NO), the control information receiving unit 201 transmits the photographing stop signal to the photographing instruction unit 202 (S109), transmits the information presentation stop signal to the information presentation instruction unit 203 (S110), and resets the shooting flag “OFF” (S111).

In the flowchart, NO in step S103 indicates the state in which photographing and information presentation are stopped, from which the control information receiving unit 201 starts photographing and information presentation. YES in step S103 and NO in step S102 indicate the state where photographing and information presentation are completed, and the control information receiving unit 201 stops photographing and information presentation. The operation of step S103 allows the control information receiving unit 201 to stop photographing and information presentation even if a person remains in front of the sensor 30, so that the same person will not be photographed repeatedly. Through the loop of the operation illustrated in FIG. 7, the photographing control apparatus 20 can make the photographing apparatus 10 photograph persons in succession for multiple authentication such as when authenticating persons successively in such a place as a ticket gate of a station.

Next, description will be given of the operation of the determination apparatus according to the first embodiment.

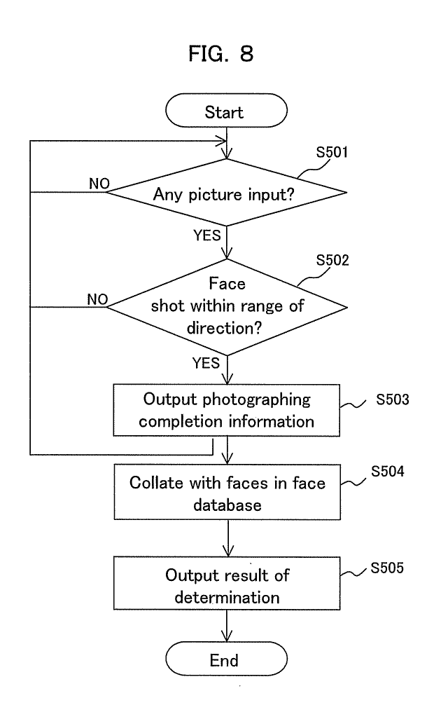

FIG. 8 is a flowchart illustrating the operation of the determination apparatus according to the first embodiment.

Initially, the determination apparatus 40 determines whether or not there is any picture input from the camera 101 through the photographing instruction unit 202, based on an instruction from the photographing instruction unit 202 (S501).

If it is determined in step S501 that there is a picture input (S501), the determination apparatus 40 determines whether or not the face of the person to be photographed seen in the input picture falls within a range of direction (S502).

If it is determined in step S502 that the direction of the face of the person to be photographed falls within a predetermined range (appropriate range) (S502, YES), the determination apparatus 40 transmits photographing completion information to the control information receiving unit 201 (S503). The determination apparatus 40 determines again whether or not there is any picture input (S501), collates the input picture with the data in the face database 50 (S504), and outputs the result of determination (identification) (S505).

On the other hand, if it is determined in step S502 that the direction of the face of the person to be photographed in the input picture does not fall within the range (S502, NO), or if it is determined in step S501 that there is no picture input from the photographing instruction unit 202 (S501, NO), the same operation is repeated.

As described above, FIG. 8 illustrates the operation when the determination apparatus 40 performs collation and outputs the result of collation after the completion of the photographing.

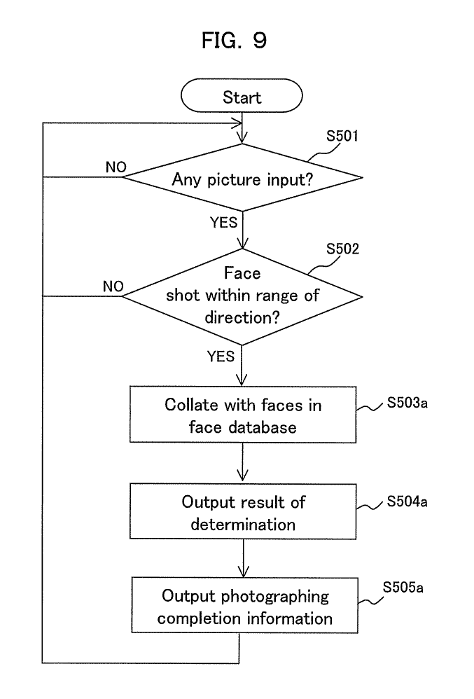

FIG. 9 is a flowchart illustrating the operation when the determination apparatus outputs the photographing completion information after the output of the result of determination (identification). The operation of step S501 and step 5502, NO, is the same as in FIG. 8, and description thereof will thus be omitted. The operation after step S502, YES, will be given below.

If it is determined in step S502 that the direction of the face of the person to be photographed falls within the range (S502, YES), the determination apparatus 40 collates the input picture with the data in the face database 50 (S503a), outputs the result of determination (identification) (S504a), transmits the photographing completion information to the control information receiving unit 201 (S505a), and returns to step S501.

Next, description will be given of the operation of the photographing instruction unit according to the first embodiment.

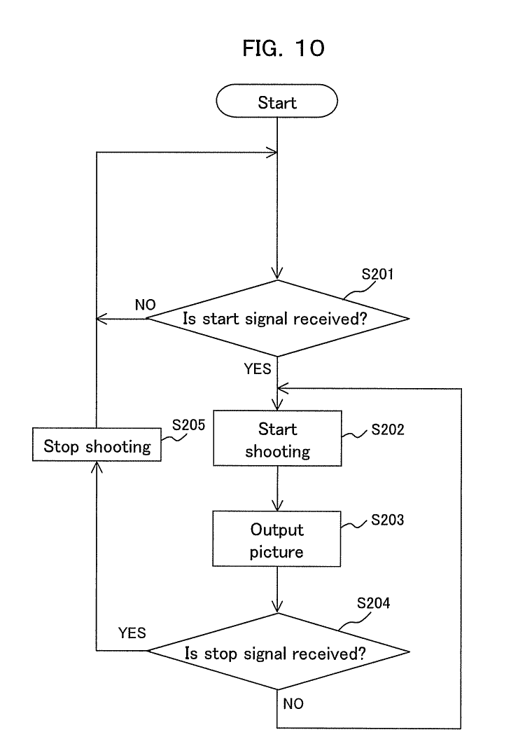

FIG. 10 is a flowchart illustrating the operation of the photographing instruction unit according to the first embodiment.

Initially, the photographing instruction unit 202 determines whether or not the photographing start signal is received from the control information receiving unit 201 (S201).

If in step S201 the photographing instruction unit 202 receives the photographing start signal (S201, YES), the photographing instruction unit 202 instructs the camera 101 to perform shooting (S202), transmits the shot picture to the determination apparatus 40 (S203), and determines whether or not the stop signal is received (S204).

If in step S204 the photographing instruction unit 202 receives the photographing stop signal (S204, YES), the photographing instruction unit 202 makes the camera 101 stop shooting (S205), and returns to step S201.

On the other hand, if the photographing instruction unit 202 does not receive the photographing stop signal (S204, NO), the photographing instruction unit 202 makes the camera 101 continue shooting (S202).

If it is determined in step S201 that the photographing instruction unit 202 does not receive the photographing start signal (S201, NO), the photographing instruction unit 202 repeats the same operation (S201).

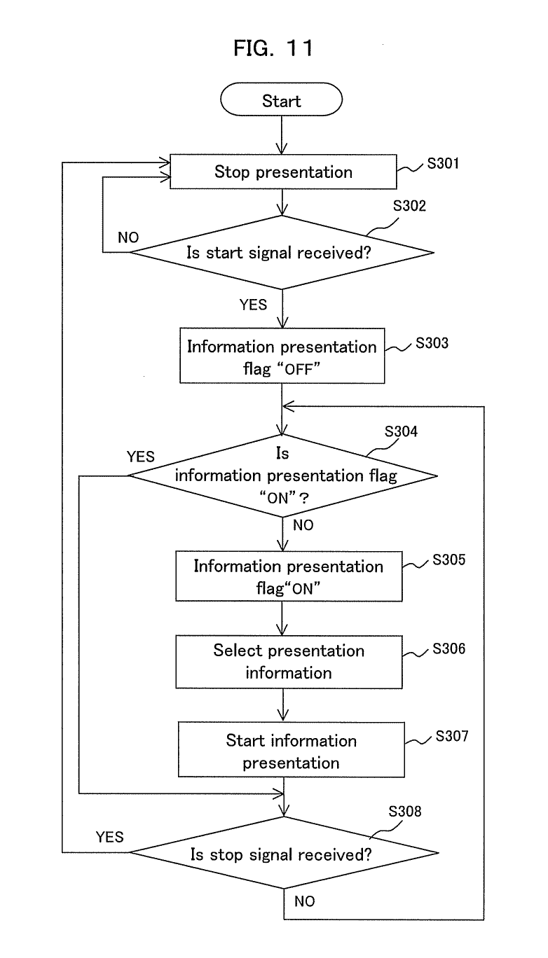

Next, the operation of the information presentation instruction unit of the first embodiment will be described with reference to the flowchart of FIG. 11.

Initially, the information presentation instruction unit 203 makes the information presentation unit 102 stop information presentation (S301), in which state the information presentation instruction unit 203 determines whether or not a presentation start signal is received from the control information receiving unit 201 (S302).

If it is determined in step S302 that the information presentation instruction unit 203 receives the presentation start signal (S302, YES), the information presentation instruction unit 203 resets an information presentation flag it retains “OFF” (S303), and determines whether or not the information presentation flag is “ON” (S304).

If it is determined in step S304 that the information presentation flag is “OFF” (S304, NO), the information presentation instruction unit 203 sets the information presentation flag “ON” (S305), selects presentation contents from a plurality of pieces of presentation information it retains in predetermined order or at random (S306), and makes the information presentation unit 102 present the presentation information selected (S307). The information presentation instruction unit 203 then determines whether or not the stop signal is received (S308).

If it is determined in step S308 that the information presentation instruction unit 203 receives the stop signal (S308, YES), the information presentation instruction unit 203 makes the information presentation unit 102 stop information presentation (S301).

On the other hand, if it is determined in step S308 that the information presentation instruction unit 203 does not receive the stop signal (S308, NO), the information presentation instruction unit 203 determines whether or not the information presentation flag is “ON” (S304).

If in step S304 the information presentation flag is “ON” (S304, YES), the information presentation instruction unit 203 determines whether or not the stop signal is received (S308).

Now, if in step S302 the information presentation instruction unit 203 does not receive the presentation start signal from the control information receiving unit 201 (S302, NO), the information presentation instruction unit 203 keeps the information presentation unit 102 stopping information presentation (S301).

Next, description will be given of the operation when the photographing control apparatus selects presentation contents.

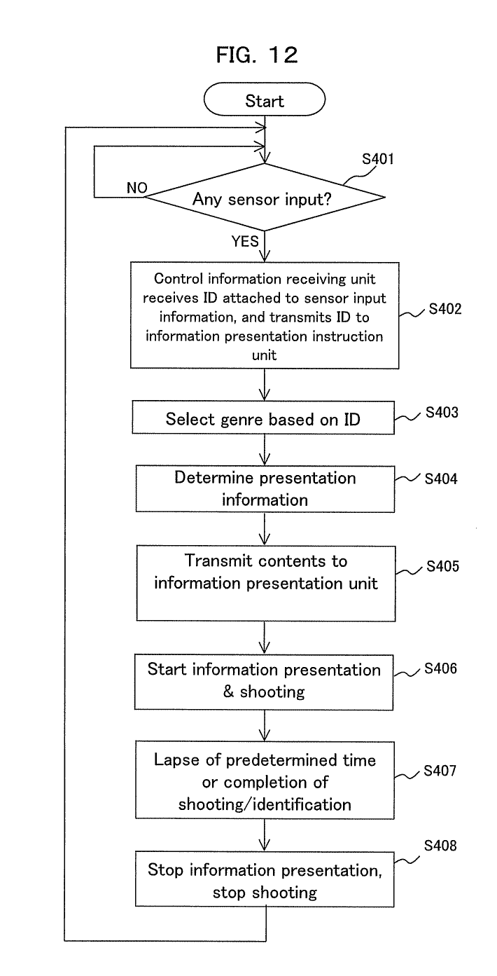

FIG. 12 is a flowchart illustrating the overall operation when presentation information is selected according to the first embodiment. In the chart, if the sensor 30 reads information that identifies an individual, ID shall be additional information that is read by the sensor 30. If the photographing control apparatus 20 is targeted for a certain user, ID shall be information that is preset for selecting a display pattern.

Initially, when a signal is input from the sensor 30 (S401, YES), the control information receiving unit 201 transmits ID to the information presentation instruction unit 203 (S402). In step S402, the information presentation instruction unit 203 may transmit user-preset information as the ID.

Receiving the ID, the information presentation instruction unit 203 refers to the presentation information setting table to determine a presentation pattern from the ID (S403), determines presentation information based on the presentation pattern and the set genre (S404), and transmits the presentation contents to the information presentation unit 102 (S405).

Receiving the presentation contents, the information presentation unit 102 presents the information. The camera 101 starts shooting (S406).

After a lapse of predetermined time or at the completion of photographing or both photographing and identification, the control information receiving unit 201 transmits stop information to the photographing instruction unit 202 and the information presentation instruction unit 203 (S407). The photographing instruction unit 202 makes the camera 101 stop shooting, and the information presentation instruction unit 203 makes the information presentation unit 102 stop presentation (S408). The procedure returns to step S401.

### Second Embodiment

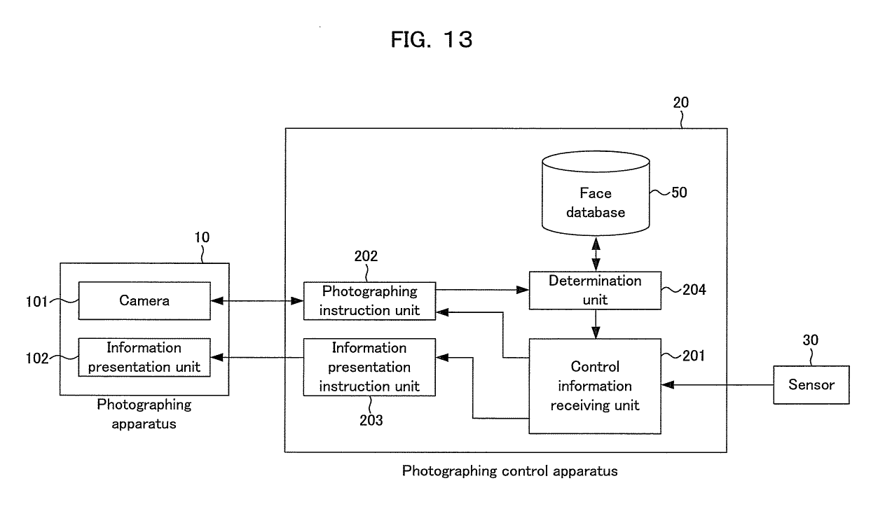

In the first embodiment, the determination apparatus 40 and the face database 50 are provided outside the photographing control apparatus 20. In a second embodiment, such components may be provided inside the photographing control apparatus as illustrated in FIG. 13.

More specifically, the second embodiment differs from the first embodiment in that a determination unit 204 having the same function as that of the determination apparatus 40 is arranged inside the photographing control apparatus 20 instead of the determination apparatus 40, along with the face database 50. In operation, a difference from the first embodiment consists in that the operation that has been performed by the determination apparatus 40 in the first embodiment is performed by the determination unit 204 in the second embodiment.

### Third Embodiment

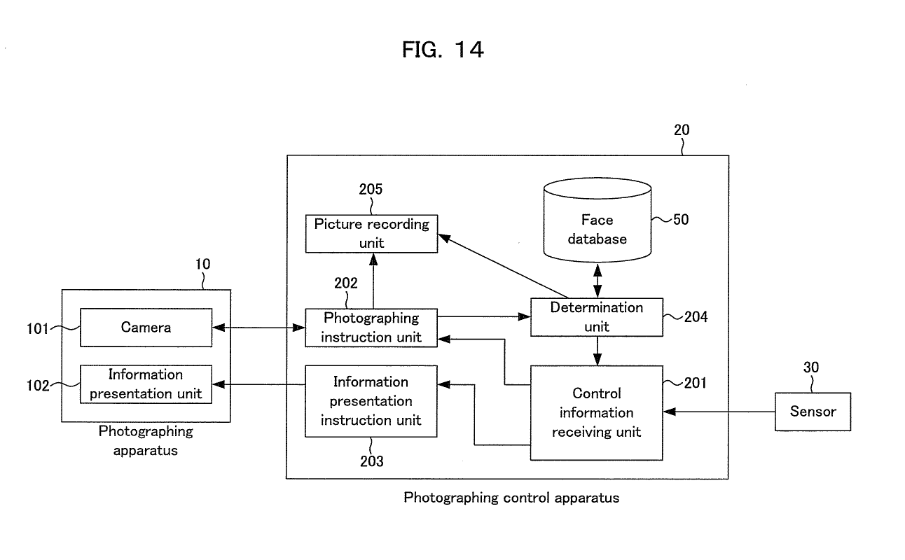

FIG. 14 is a block diagram illustrating an example of the overall configuration of a third embodiment.

The third embodiment differs from the second embodiment in that a picture recording unit 205 is newly provided. The picture recording unit 205 stores pictures transmitted from the photographing instruction unit 202. Whether or not to store pictures is determined by the determination unit 204 when performing face authentication.

In operation, a difference from the second embodiment consists in that the determination unit 204 outputs the result of determination of face authentication and determines whether or not to make the picture recording unit 205 store the picture transmitted to the picture recording unit 205 in step 5505 of FIG. 8 or in step S504a of FIG. 9. Another difference from the second embodiment lies in that the photographing instruction unit 202 transmits the picture to the determination unit 204 and the picture recording unit 205 in step 5203 of FIG. 10.

The determination unit 204 will not store the picture into the picture recording unit 205 if the person to be photographed is registered in the face database, and stores the picture into the picture recording unit 205 only if the person to be photographed is not registered in the face database. Since the pictures of non-registrants are stored into the picture recording unit 205, it is possible to identify a non-registrant, for example, when the non-registrant impersonates a registrant and attempts face authentication. The criterion by which the determination unit 204 determines whether or not to store may be set in advance, or may be freely configured.

### Fourth Embodiment

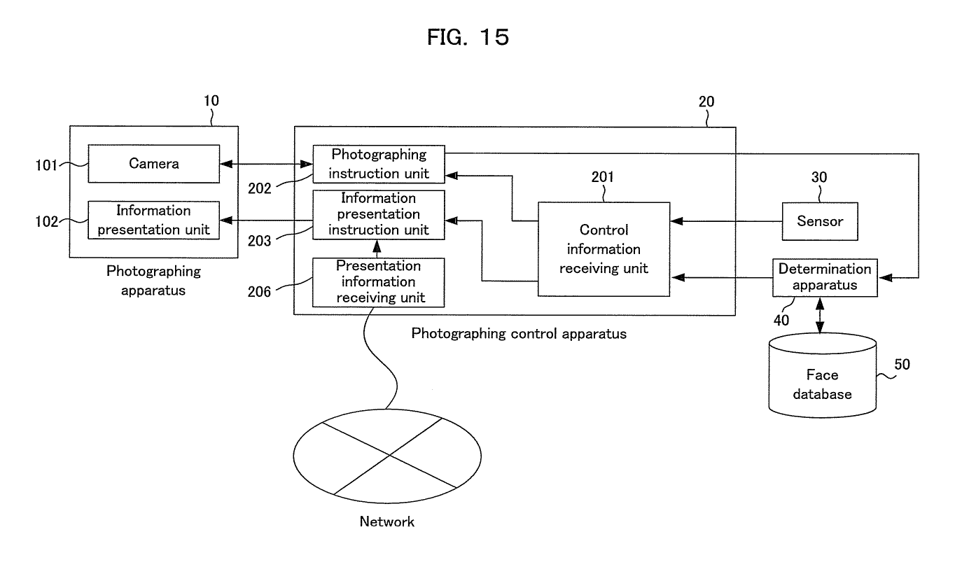

FIG. 15 is a block diagram illustrating an example of the overall configuration of a fourth embodiment.

The fourth embodiment differs from the first embodiment in that a presentation information receiving unit 206 is newly provided. The presentation information receiving unit 206 is connected to a network. The presentation information receiving unit 206 downloads latest information that the person to be photographed can recognize in a short time, such as a weather forecast, traffic information, exchange quotations, current prices at an auction, and sports scores, over the network, and transmits the information to the information presentation instruction unit 203. Reading presentation information from exterior makes it possible to present not only presentation information that is registered in advance and has limited display patterns, such as fortune messages and flicker patterns, but also a wider range of information to interest the person to be photographed.

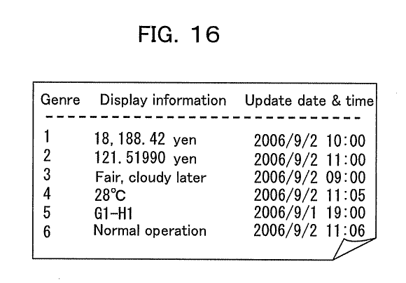

FIG. 16 is a latest presentation information table which the presentation information receiving unit according to the fourth embodiment retains.

The presentation information receiving unit 206 retains downloaded information, the update date and time, and the corresponding genre of the downloaded information in association with each other as illustrated in FIG. 16. The information to be input to the presentation information receiving unit 206 may be input by the user or administrator.

In operation, a difference from the first embodiment consists in that the information presentation instruction unit 203 constantly accepts inputs from the presentation information receiving unit 206.

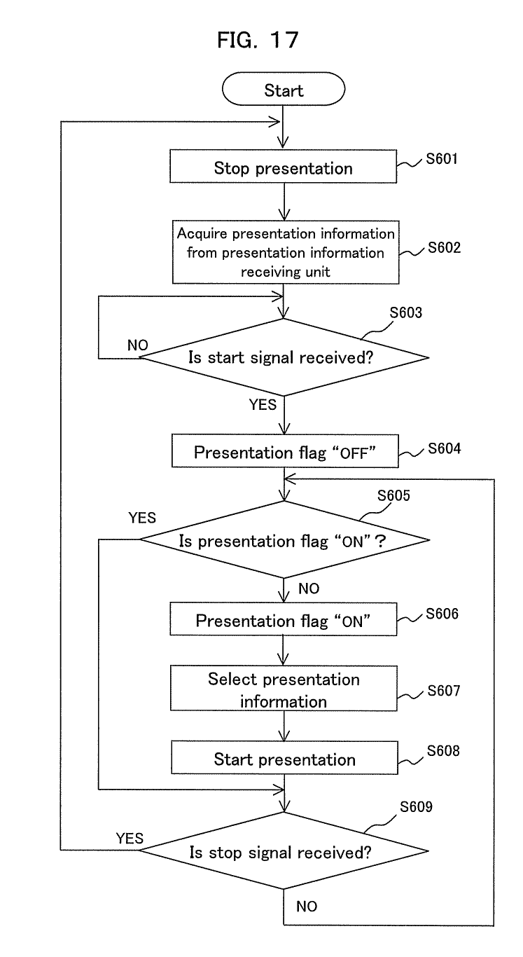

FIG. 17 is a flowchart illustrating the operation of the information presentation instruction unit according to the fourth embodiment.

The information presentation instruction unit 203 initially makes the information presentation unit 102 stop information presentation (S601), in which state the information presentation instruction unit 203 acquires presentation information from the presentation information receiving unit 206 (S602). If the information presentation instruction unit 203 receives the start signal from the control information receiving unit 201 (S603, YES), the information presentation instruction unit 203 resets the information presentation flag it retains “OFF” (S604), and determines whether or not the information presentation flag is “ON” (S605).

If it is determined in step S605 that the information presentation flag is “OFF” (S605, NO), the information presentation instruction unit 203 sets the information presentation flag “ON” (S606). The information presentation instruction unit 203 selects presentation information from a plurality of pieces of presentation information it retains, including the presentation information acquired from the presentation information receiving unit 206, in predetermined order or at random (S607), and makes the information presentation unit 102 present the presentation information selected (S608). The information presentation instruction unit 203 then determines whether or not the stop signal is received (S609).

As has been described in the first embodiment, the information presentation instruction unit may select presentation information depending on age, gender, occupation, and the like based on the ID of the person to be photographed if the ID is available. In such a case, presentation priority may be given between genres based on the ID. For example, 1) stock prices and 2) weather forecasts are presented in this order to working persons of age 30s to 50s to be photographed.

If it is determined in step S609 that the information presentation instruction unit 203 receives the stop signal (S609, YES), the information presentation instruction unit 203 makes the information presentation unit 102 stop information presentation (S601).

On the other hand, if the information presentation instruction unit 203 does not receive the stop signal (S609, NO), the information presentation instruction unit 203 returns to step S605.

If in step S605 the information presentation flag is “ON” (S605, YES), the information presentation instruction unit 203 proceeds to step S609.

### Fifth Embodiment

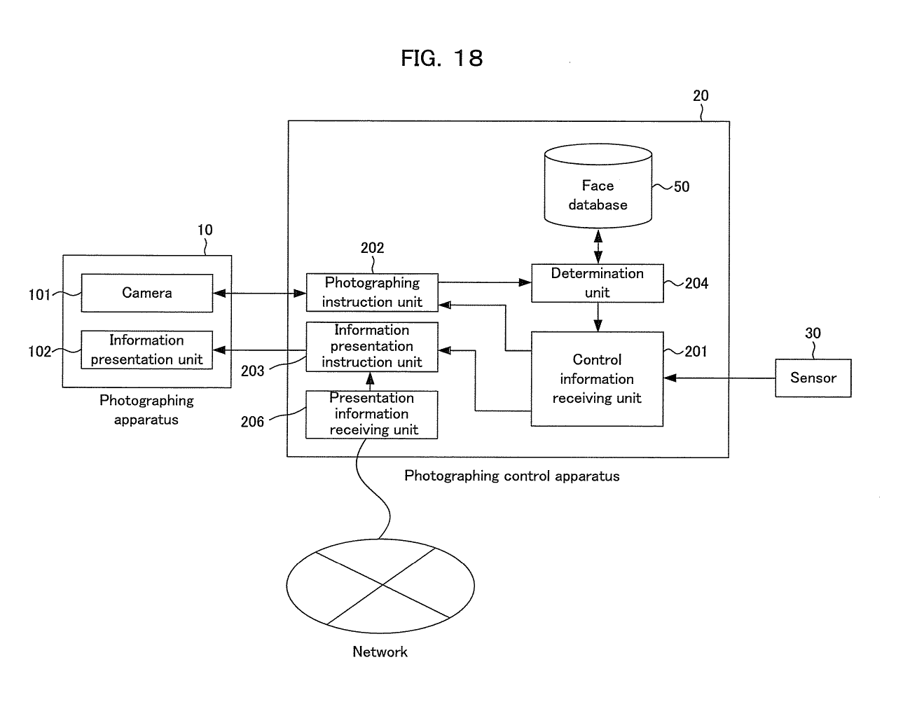

FIG. 18 is a block diagram illustrating the overall configuration of a fifth embodiment.

In the fifth embodiment, the face database 50 and a determination unit 204 are further provided in the photographing control apparatus 20 of the fourth embodiment.

In operation, the fifth embodiment is the same as the fourth embodiment in the operation of the information presentation instruction unit 203 and the presentation information receiving unit 206, and is the same as the second embodiment other than in the operation of the information presentation instruction unit 203 and the presentation information receiving unit 206.

### Sixth Embodiment

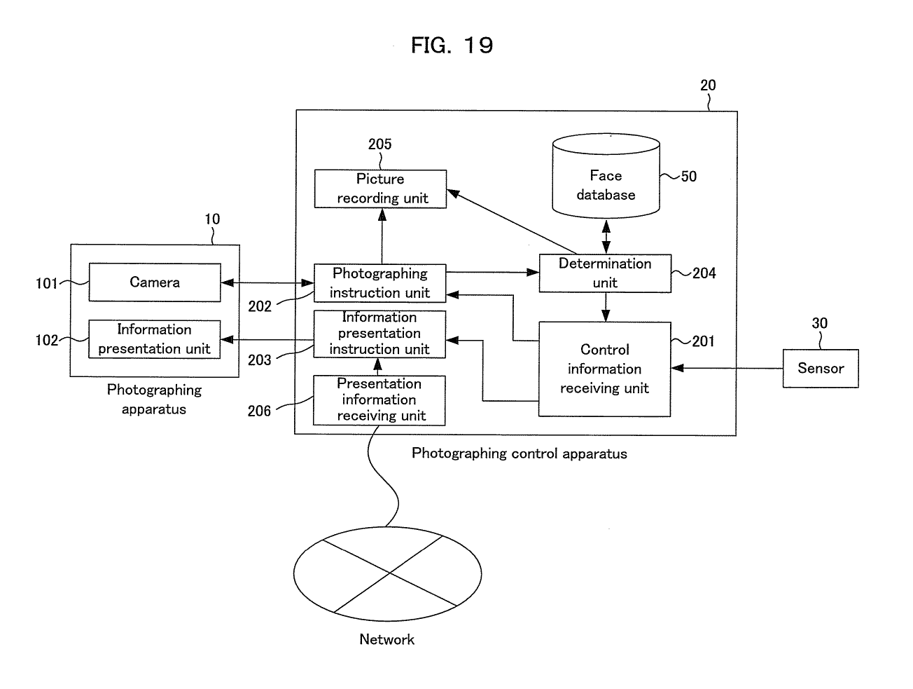

FIG. 19 is a block diagram illustrating the overall configuration of a sixth embodiment.

In the sixth embodiment, a picture recording unit 205 is further provided in the photographing control apparatus 20 of the fifth embodiment.

In operation, the sixth embodiment is the same as the fourth embodiment in the operation of the information presentation instruction unit 203 and the presentation information receiving unit 206, and is the same as the third embodiment other than in the operation of the information presentation instruction unit 203 and the presentation information receiving unit 206.

As has been described, according to the present invention, it is possible to make a person to be photographed look to a proper direction with respect to the camera and make the face of the imaging subject turned to the proper direction with respect to the camera without interfering with photographing or passage.

A photographing control program according to the present invention can be provided through the provision of programs that make a computer perform the operations described in the flowcharts or steps depicts in the foregoing respective embodiments. Such programs can be recorded on computer-readable media and executed by computers. The computers include a host unit such as a personal computer, a test equipment controller, and such a controller as a storage device MPU and a CPU. The computer-readable media include portable storage media such as a CD-ROM, flexible disk, DVD disc, magneto-optic disk, and IC card, databases that contain computer programs, other computers and databases thereof, and even online transmission media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An imaging control apparatus for controlling an imaging apparatus that presents presentation information and captures an image of a person, the imaging control apparatus includes:
an identification information acquisition unit that acquires identification information unique to the person;
an information presentation instruction unit that refers to presentation information setting information which associates the identification information and the presentation information with each other, and instructs the imaging apparatus to present presentation information that the presentation information setting information associates with identification information acquired by the identification information acquisition unit; and
an imaging instruction unit that instructs the imaging apparatus to capture an image of the person while the instruction presentation instruction unit instructs to present the presentation information.

2. The imaging control apparatus according to claim 1, wherein
the presentation information is optical information or acoustic information.

3. The imaging control apparatus according to claim 1, wherein
the information presentation instruction unit instructs to present the presentation information until a notification of completion of the capturing of the image is received.

4. The imaging control apparatus according to claim 1, wherein
the information presentation instruction unit instructs to present the presentation information until a notification of completion of authentication on the person based on the capturing of the image is received.

5. An imaging apparatus for presenting presentation information and capturing an image of a person, the apparatus includes:
an identification information acquisition unit that acquires identification information unique to the person;
an information presentation unit that refers to presentation information setting information which associates the identification information and the presentation information with each other, and presents presentation information that the presentation information setting information associates with identification information acquired by the identification information acquisition unit; and
an imaging unit that captures an image of the person while the information presentation unit presents the presentation information.

6. The imaging apparatus according to claim 5, wherein
the presentation information is optical information or acoustic information.

7. The imaging apparatus according to claim 5, wherein
the information presentation unit presents the presentation information until the capturing of the image by the imaging unit completes.

8. The imaging apparatus according to claim 5, wherein
the information presentation unit presents the presentation information until authentication on the person based on the capturing of the image by the imaging unit completes.

9. An imaging control method for controlling an imaging apparatus that presents presentation information and captures an image of a person, the method includes:
acquiring identification information unique to the person; referring to presentation information setting information which associates the identification information and the presentation information with each other, and instructing the imaging apparatus to present presentation information that the presentation information setting information associates with identification information acquired; and instructing the imaging apparatus to capture an image of the person while instructing to present the presentation information.

10. The imaging control method according to claim 9, wherein
the presentation information is optical information or acoustic information.

11. The imaging control method according to claim 9, wherein
the instructing to present information instructs to present the presentation information until a notification of completion of imaging is received.

12. The imaging control method according to claim 9, wherein
the instructing to present presentation information instructs to present the presentation information until a notification of completion of authentication on the person based on the capturing of the image is received.

13. A computer-readable medium having recorded thereon an imaging control program, the imaging control program being capable of controlling an imaging apparatus that presents presentation information and captures an image of a person, the imaging control program making the computer perform:
acquiring identification information unique to the person; referring to presentation information setting information which associates the identification information and the presentation information with each other, and instructing the imaging apparatus to present presentation information that the presentation information setting information associates with identification information acquired; and instructing the imaging apparatus to capture an image of the person while instructing to present the presentation information.

14. The computer-readable medium according to claim 13, wherein
the presentation information is optical information or acoustic information.

15. The computer-readable medium according to claim 13, wherein
the instructing to present presentation information instructs to present the presentation information until a notification of completion of the capturing of the image is received.

16. The computer-readable medium according to claim 13, wherein
the instructing to present presentation information instructs to present the presentation information until a notification of completion of authentication on the person based on the capturing of the image is received.
